(19) United States
(12) Patent Application Publication
(10) Pub. No.: US 2026/0326452 A1
(43) Pub. Date: Oct. 22, 2026

(54) LIQUID SUPPLY APPARATUS, IMAGE FORMING APPARATUS, AND LIQUID DISCHARGE APPARATUS

(71) Applicants: Takahiro YOSHIDA, Kanagawa (JP); Yuuta AOKI, Kanagawa (JP)

(72) Inventors: Takahiro YOSHIDA, Kanagawa (JP); Yuuta AOKI, Kanagawa (JP)

(21) Appl. No.: 19/639,326

(22) Filed: Apr. 6, 2026

(30) Foreign Application Priority Data
Apr. 16, 2025 (JP) 2025-067523

(51) Int. Cl. B41J 2/175; B41J 2/045; B41J 2/185

(52) U.S. Cl. CPC B41J 2/17563; B41J 2/0451; B41J 2/17523; B41J 2/17596; B41J 2/185; B41J 2/04581; B41J 2202/12

(57) ABSTRACT

A liquid supply apparatus includes: a first tank to store a liquid to be supplied to a head, to discharge a liquid; a second tank to store the liquid to be supplied to the first tank; a liquid path including: a first path coupling the first tank and the head, to supply the liquid from the first tank to the head in a supply direction; a second path coupling the second tank and the first tank, to supply the liquid from the second tank to the first tank in the supply direction; a feeding pump in the second path and driven at an operating duty cycle, to feed the liquid from the second tank to the first tank; a filter disposed downstream from the feeding pump in the supply direction in the second path; and circuitry configured to measure the operating duty cycle of the feeding pump.

### CROSS-REFERENCE TO RELATED APPLICATIONS

This patent application is based on and claims priority pursuant to 35 U.S.C. § 119(a) to Japanese Patent Application No. 2025-067523, filed on Apr. 16, 2025, in the Japan Patent Office, the entire disclosure of which is hereby incorporated by reference herein.

### BACKGROUND

### Technical Field

The present embodiment relates to a liquid supply apparatus, an image forming apparatus, and a liquid discharge apparatus.

### Related Art

A liquid such as ink is circulated or supplied to a liquid supply target such as a circulation-type head. To reduce a pressure pulsation during driving a feeding pump, an air path is provided to connect gas layer portions of a positive pressure tank and a negative pressure tank, and an open/close valve is provided to open and close the air path. Further, there is a technology to reduce pressure fluctuation of a tank coupled to a circulation-type head.

### SUMMARY

The present disclosure described herein provides a liquid supply apparatus including: a first tank to store a liquid to be supplied to a head, to discharge a liquid; a second tank to store the liquid to be supplied to the first tank; a liquid path including: a first path coupling the first tank and the head, to supply the liquid from the first tank to the head in a supply direction; a second path coupling the second tank and the first tank, to supply the liquid from the second tank to the first tank in the supply direction; a feeding pump in the second path and driven at an operating duty cycle, to feed the liquid from the second tank to the first tank; a filter disposed downstream from the feeding pump in the supply direction in the second path; and circuitry configured to: measure the operating duty cycle of the feeding pump; and determine a lifetime of the filter based on the operating duty cycle measured.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic explanatory diagram of a printing apparatus;

FIG. 2 is a plan explanatory view of an example of a head unit of the printing apparatus;

FIG. 3 is an external perspective explanatory view of a liquid discharge head of the head unit;

FIG. 4 is a cross-sectional explanatory view in a direction orthogonal to a nozzle array direction (a liquid chamber longitudinal direction) of the same liquid discharge head;

FIG. 5 is a piping diagram of a liquid supply mechanism;

FIG. 6 is a functional block diagram of a controller;

FIG. 7A is a diagram illustrating an example of a configuration of a conventional liquid circulation system;

FIG. 7B is a diagram illustrating an example of a configuration of a conventional liquid supply system;

FIG. 8A is a graph illustrating an example of a liquid circulation apparatus according to a first embodiment;

FIG. 8B is a graph illustrating an example of the liquid circulation apparatus according to the first embodiment;

FIG. 9 is a graph illustrating an example of a simulation result assuming a case where, by passing liquid through a filter, a fluid resistance value increases and a flow rate due to operation of a feeding pump decreases to 80 mL/min;

FIG. 10A is a graph illustrating an example of a result of calculating an operating duty cycle when the flow rate of the feeding pump is changed;

FIG. 10B is a flowchart illustrating an example of a flow of a measurement process of an operating duty cycle in the liquid circulation apparatus according to the first embodiment;

FIG. 11 is a graph illustrating an example of a simulation result when the flow rate of the feeding pump is 30 mL/min, which is below an ink circulation amount of 38 mL/min;

FIG. 12 is a graph illustrating transitions of liquid level heights of a supply tank and a collection tank when the flow rate of the feeding pump is 100 mL/min;

FIG. 13 is a graph illustrating transitions of liquid level heights of the supply tank and the collection tank when the flow rate of the feeding pump is 30 mL/min;

FIG. 14 is a flowchart illustrating an example of a flow of a measurement process of an operating duty cycle in a liquid circulation apparatus according to a second embodiment;

FIG. 15 is a graph illustrating an example of operation of the feeding pump when the flow rate of the feeding pump is 45 mL/min;

FIG. 16 is a graph illustrating an operating time and a drive cycle of the feeding pump with respect to an operating duty cycle;

FIG. 17 is a flowchart illustrating an example of a flow of a measurement process of an operating duty cycle in a liquid circulation apparatus according to a third embodiment;

FIG. 18 is a graph illustrating the flow rate of the feeding pump, an outflow flow rate of the supply tank, and an inflow flow rate of the collection tank when a discharge flow from a head is continuously discharged with the ink circulation amount of 38 mL/min;

FIG. 19 is a graph illustrating an example of an operating duty cycle under the conditions illustrated in FIG. 18, assuming a case where the filter has been clogged and the flow rate of the feeding pump has decreased;

FIG. 20 is a flowchart illustrating an example of a flow of a measurement process of an operating duty cycle in a liquid circulation apparatus according to a fourth embodiment;

FIG. 21 is a graph illustrating an example of the flow rate of the feeding pump in an intermittent operation;

FIG. 22 is a graph in which operations of the feeding pump at operating times (1) to (9) illustrated in FIG. 21 are each indicated by an operating duty cycle; and

FIG. 23 is a flowchart illustrating an example of a flow of a measurement process of an operating duty cycle in a liquid circulation apparatus according to a fifth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of a liquid supply apparatus, an image forming apparatus, and a liquid discharge apparatus will be described in detail below with reference to the accompanying drawings.

### First Embodiment (Printing Apparatus)

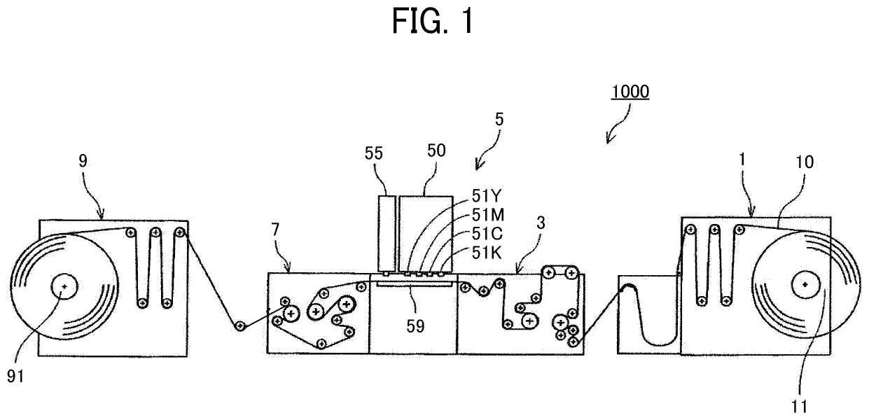

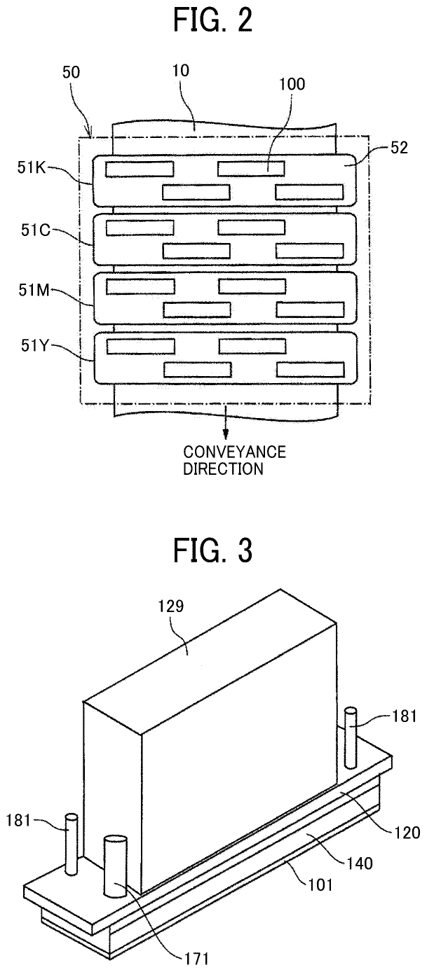

First, a printing apparatus, which is an example of an apparatus that discharges a liquid according to the present embodiment, will be described with reference to FIG. 1 and FIG. 2. FIG. 1 is a schematic explanatory diagram of the printing apparatus, and FIG. 2 is a plan explanatory view of an example of a head unit of the printing apparatus.

A printing apparatus 1000 (an example of the image forming apparatus or the liquid discharge apparatus), which is an apparatus that discharges a liquid, includes a carry-in unit 1 to carry in a continuous medium 10, a guide conveyance unit 3 to guide and convey the continuous medium 10 carried in by the carry-in unit 1 to a printing unit 5, the printing unit 5 to perform printing in which a liquid is discharged onto the continuous medium 10 to form an image, a drying unit 7 to dry the continuous medium 10, a discharge unit 9 to discharge the continuous medium 10, etc.

The continuous medium 10 is fed out from a supply roll roller 11 of the carry-in unit 1, is guided and conveyed by the rollers of the carry-in unit 1, the guide conveyance unit 3, the drying unit 7, and the discharge unit 9, and is wound up by a take-up roller 91 of the discharge unit 9.

In the printing unit 5, the continuous medium 10 is conveyed on a conveyance guide member 59 while facing a head unit 50 and a head unit 55, an image is formed by a liquid discharged from the head unit 50, and post-processing is performed with a processing liquid discharged from the head unit 55.

Here, in the head unit 50, for example, full-line head arrays 51K, 51C, 51M, and 51Y for four colors are arranged from an upstream side in a medium conveyance direction. When the colors are not distinguished, the full-line head arrays 51K, 51C, 51M, and 51Y are collectively referred to as “head array 51”.

Each head array 51 is a liquid discharging unit, and discharges liquids of black K, cyan C, magenta M, and yellow Y onto the conveyed continuous medium 10, respectively. Note that the types and number of colors are not limited thereto.

As illustrated in FIG. 2, the head array 51 includes liquid discharge heads 100 arranged in a staggered manner on a base member 52, for example. Each of the liquid discharge heads 100 are an example of a head that discharges a liquid such as ink. However, the configuration is not limited thereto. The liquid discharge heads 100 are also simply referred to as “heads”.

### Liquid Discharge Head

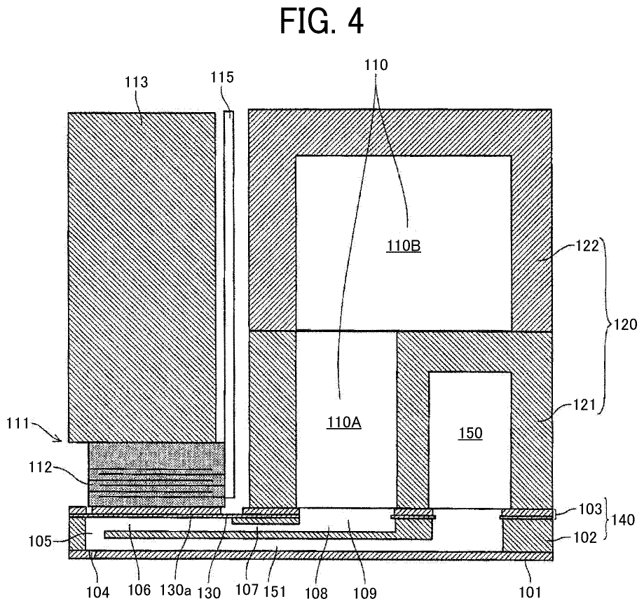

Next, an example of the liquid discharge head 100 will be described with reference to FIG. 3 and FIG. 4. FIG. 3 is an external perspective explanatory view of the liquid discharge head, and FIG. 4 is a cross-sectional explanatory view in a direction orthogonal to a nozzle array direction (a liquid chamber longitudinal direction) of the same liquid discharge head.

The liquid discharge head 100 is an example of a liquid supply target to which a liquid such as ink is supplied.

Further, the liquid discharge head 100 is an example of a head that discharges a liquid. Further, the liquid discharge head 100 may be an example of a circulation target medium in which a liquid circulates, such as a circulation-type liquid discharge head in which ink circulates in common liquid chambers such as a supply-side common liquid chamber 110 and a discharge-side common liquid chamber 150, and a circulation-type liquid discharge head in which ink circulates in the vicinity of a nozzle 104.

The liquid discharge head 100 is formed by laminating and bonding a nozzle plate 101, a flow path plate 102, and a diaphragm member 103 as a wall surface member. The liquid discharge head 100 includes a piezoelectric actuator 111 that displaces a vibration region 130 (diaphragm) of the diaphragm member 103, a common liquid chamber member 120 that also serves as a frame member of the head, and a cover 129. Note that a portion formed of the flow path plate 102 and the diaphragm member 103 is referred to as flow path member 140.

The nozzle plate 101 includes a plurality of nozzles 104 that discharge a liquid.

The flow path plate 102 forms an individual liquid chamber 106 that communicates with the nozzle 104 via a nozzle communication passage 105, a supply-side fluid resistance portion 107 that communicates with the individual liquid chamber 106, and a through hole and a groove portion that serve as a liquid introduction portion 108 that communicates with the supply-side fluid resistance portion 107. The nozzle communication passage 105 is a flow path that is coupled to and communicates with the nozzle 104 and the individual liquid chamber 106, respectively. Further, the liquid introduction portion 108 communicates with the supply-side common liquid chamber 110 via an opening 109 of the diaphragm member 103.

The diaphragm member 103 includes the deformable vibration region 130 that forms a wall surface of the individual liquid chamber 106 of the flow path plate 102. Here, the diaphragm member 103 has a two-layer structure (not limited thereto), and is formed of a first layer that forms a thin portion from the flow path plate 102 side and a second layer that forms a thick portion, and the first layer forms the deformable vibration region 130 in a portion corresponding to the individual liquid chamber 106.

The piezoelectric actuator 111 including an electromechanical transducer element is disposed on a side of the diaphragm member 103 opposite to the individual liquid chamber 106, as a driving unit (actuator unit, pressure generating unit) that deforms the vibration region 130 of the diaphragm member 103.

In the piezoelectric actuator 111, a piezoelectric member bonded on a base member 113 is subjected to groove processing by half-cut dicing to form a predetermined number of columnar piezoelectric elements 112 in a comb shape at predetermined intervals.

The piezoelectric element 112 is bonded to a protruding portion 130a that is an island-shaped thick portion formed in the vibration region 130 of the diaphragm member 103. Further, a flexible wiring member 115 is coupled to the piezoelectric element 112.

The common liquid chamber member 120 forms the supply-side common liquid chamber 110 and the discharge-side common liquid chamber 150. The supply-side common liquid chamber 110 communicates with a supply port 171, and the discharge-side common liquid chamber 150 communicates with a discharge port 181.

Here, the common liquid chamber member 120 includes a first common liquid chamber member 121 and a second common liquid chamber member 122. The first common liquid chamber member 121 is bonded to the diaphragm member 103 side of the flow path member 140, and the second common liquid chamber member 122 is laminated on and bonded to the first common liquid chamber member 121.

The first common liquid chamber member 121 forms a downstream-side common liquid chamber 110A that is a part of the supply-side common liquid chamber 110 and communicates with the liquid introduction portion 108, and the discharge-side common liquid chamber 150 that communicates with a discharge flow path 151. Further, the second common liquid chamber member 122 forms an upstream-side common liquid chamber 110B that is a remaining portion of the supply-side common liquid chamber 110.

Further, the flow path plate 102 forms the discharge flow path 151 that extends along a surface direction of the flow path plate 102 and communicates with each individual liquid chamber 106 via the nozzle communication passage 105. The discharge flow path 151 communicates with the discharge-side common liquid chamber 150.

In the liquid discharge head 100, for example, a voltage applied to the piezoelectric element 112 is lowered from a reference potential (intermediate potential) so that the piezoelectric element 112 contracts to pull the vibration region 130 of the diaphragm member 103 such that a volume of the individual liquid chamber 106 expands, and thereby a liquid flows into the individual liquid chamber 106.

Thereafter, the liquid discharge head 100 increases the voltage applied to the piezoelectric element 112 to extend the piezoelectric element 112 in a lamination direction and deform the vibration region 130 of the diaphragm member 103 in a direction toward the nozzle 104 to contract the volume of the individual liquid chamber 106. Accordingly, the liquid in the individual liquid chamber 106 is pressurized, and the liquid is discharged from the nozzle 104. That is, the nozzle 104 functions as an example of an outflow unit that causes a liquid to flow out from the liquid discharge head 100, which is an example of a liquid supply target.

Further, a liquid that is not discharged from the nozzle 104 passes through the nozzle 104, is discharged from the discharge flow path 151 to the discharge-side common liquid chamber 150, and is supplied again from the discharge-side common liquid chamber 150 to the supply-side common liquid chamber 110 through an external circulation path.

A driving method of the liquid discharge head 100 is not limited to the above example (pulling-pushing driving), and pulling driving, pushing driving, etc. may also be performed depending on how a drive waveform is applied.

### Liquid Circulation Mechanism

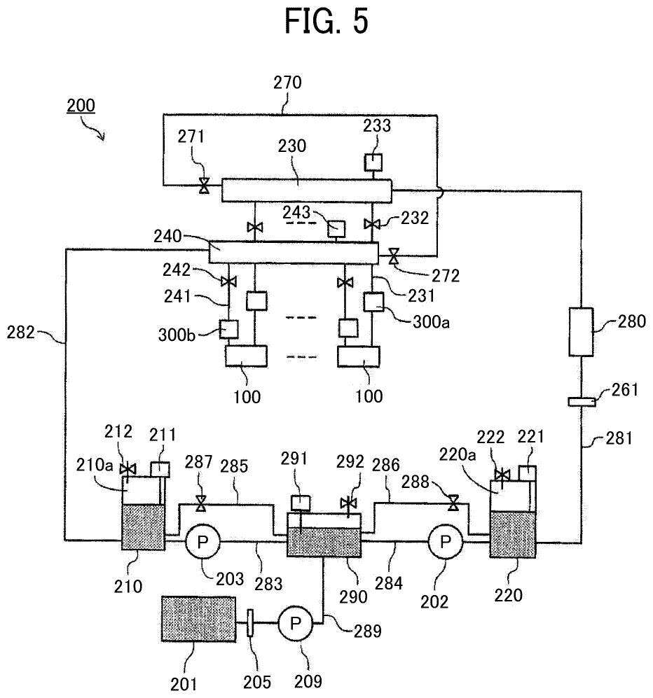

Next, a liquid circulation mechanism (an example of a liquid supply apparatus or a liquid circulation apparatus) in the apparatus that discharges the liquid according to the present embodiment will be described with reference to FIG. 5. FIG. 5 is a piping diagram of the liquid supply mechanism. A plurality of circulatable liquid discharge heads 100 is arranged in a line in a width direction of the continuous medium 10, and circulates a liquid.

A liquid circulation mechanism 200 includes a main tank 201 (liquid tank), which is a liquid storage unit that stores a liquid to be discharged from the liquid discharge head 100, a first sub tank 220 (pressurizing sub tank), a second sub tank 210 (depressurizing sub tank), a third sub tank 290, a first feeding pump 202, a second feeding pump 203, and a third feeding pump 209.

The liquid circulation mechanism 200 further includes a first manifold 230 and a second manifold 240 with which the plurality of liquid discharge heads 100 communicates, a first head tank 300a and a second head tank 300b for each liquid discharge head 100, and a degassing device which is a degassing unit that removes a dissolved gas in the liquid. Details of the first head tank 300a and the second head tank 300b (hereinafter, when not distinguished, referred to as head tank 300 (buffer tank)) will be described later.

Here, a third sub tank 290 is disposed between the first sub tank 220 and the second sub tank 210, and a liquid is fed (supplied) from the main tank 201 to the third sub tank 290 by the third feeding pump 209 via a liquid path 289 including a filter 205.

The third sub tank 290 includes a liquid level detecting unit 291 and a solenoid valve 292 which constitutes an atmospheric opening mechanism that opens an inside thereof to atmosphere.

The third sub tank 290 and the second sub tank 210 are coupled through a liquid path 283, and the second feeding pump 203 is provided in the liquid path 283. Further, the third sub tank 290 and the second sub tank 210 are coupled through a backflow liquid path 285, and a solenoid valve 287 is provided in the backflow liquid path 285.

The second sub tank 210 includes a gas chamber 210a, and has a configuration in which a liquid and a gas coexist.

The second sub tank 210 is provided with a liquid level detecting unit 211 that detects a liquid level, and a solenoid valve 212 serving as an atmospheric opening mechanism that opens an inside thereof to atmosphere.

The third sub tank 290 and the first sub tank 220 are coupled through a liquid path 284, and the first feeding pump 202 is provided in the liquid path 284. Further, the third sub tank 290 and the first sub tank 220 are coupled through a backflow liquid path 286, and a solenoid valve 288 is provided in the backflow liquid path 286.

The first sub tank 220 includes a gas chamber 220a, and has a configuration in which a liquid and a gas coexist.

The first sub tank 220 is provided with a liquid level detecting unit 221 that detects a liquid level, and a solenoid valve 222 serving as an atmospheric opening mechanism that opens an inside thereof to atmosphere.

The first sub tank 220 is coupled to the first manifold 230 through a liquid path 281 including a degassing device 280 and a filter 261. The liquid path 281 is also referred to as a “first path”.

The first manifold 230 communicates with the supply port 171 (supply opening) side of the liquid discharge head 100 via a supply path 231. The supply path 231 is coupled to the supply port 171 of the liquid discharge head 100 via the first head tank 300a. In the supply path 231, a solenoid valve 232 that opens and closes the path is provided on an upstream side of the first head tank 300a. The solenoid valve 232 is provided in accordance with the number of liquid discharge heads 100, and is individually controllable to be opened and closed. Further, a pressure sensor 233 is provided in the first manifold 230.

The second sub tank 210 is coupled to the second manifold 240 via a liquid path 282. The liquid path 282 is also referred to as a “third path”.

The second manifold 240 communicates with the discharge port 181 (discharge opening) side of the liquid discharge head 100 via a discharge path 241. The discharge path 241 is coupled to the discharge port 181 of the liquid discharge head 100 via the second head tank 300b. In the discharge path 241, a solenoid valve 242 that opens and closes the path is provided on a downstream side of the second head tank 300b. The solenoid valve 242 is provided in accordance with the number of liquid discharge heads 100, and is individually controllable to be opened and closed. Further, a pressure sensor 243 is provided in the second manifold 240.

Further, a bypass path 270 that passes through the first manifold 230 and the second manifold 240 is provided. The bypass path 270 is provided with a solenoid valve 271 on the first manifold 230 side and a solenoid valve 272 on the second manifold 240 side.

Here, a circulation path is configured of a path that returns from the third sub tank 290 to the third sub tank 290 through the liquid path 284, the first sub tank 220, the liquid path 281, the degassing device, the first manifold 230, the liquid discharge head 100, the second manifold 240, and the second sub tank 210.

Further, the solenoid valves 232, 242, 271, and 272 constitute a switching unit that switches between a first path in which a bypass path 270 constitutes a part of the circulation path with the liquid discharge head 100 being isolated from the circulation path, and a second path in which the liquid discharge head 100 constitutes a part of the circulation path with the bypass path 270 being isolated from the circulation path.

That is, the liquid circulation mechanism 200 closes the solenoid valves 232 and 242 and opens the solenoid valves 271 and 272, whereby a first path is configured in which the bypass path 270 becomes a part of the circulation path and the liquid discharge head 100 does not constitute a part of the circulation path.

Further, the liquid circulation mechanism 200 opens the solenoid valves 232 and 242 and closes the solenoid valves 271 and 272, whereby a second path is configured in which the liquid discharge head 100 becomes a part of the circulation path and the bypass path 270 does not constitute a part of the circulation path.

Further, the liquid circulation mechanism 200 constitutes a unit that generates a pressure by which a liquid circulates in the circulation path, by the first sub tank 220, the second sub tank 210, the first feeding pump 202, and the second feeding pump 203.

Next, supply and circulation of the liquid will be described.

### (1) Liquid Feeding From the Main Tank 201 to the Third Sub Tank 290

When a shortage of the liquid is detected by the liquid level detecting unit 291, the third feeding pump 209 is used to supply the liquid from the main tank 201 to the third sub tank 290 via the liquid path 289 until the liquid level detecting unit 291 indicates a full liquid level.

### (2) Liquid Feeding From the Third Sub Tank 290 to the First Sub Tank 220

Using the first feeding pump 202, the liquid is supplied from the third sub tank 290 to the first sub tank 220 via the liquid path 284.

### (3) Liquid Feeding From the Second Sub Tank 210 to the Third Sub Tank 290

Using the second feeding pump 203, the liquid is supplied from the second sub tank 210 to the third sub tank 290 via the liquid path 283.

The liquid paths 283 and 284 are also collectively referred to as a “second path”.

### (4) Liquid Feeding From the First Sub Tank 220 to the Liquid Discharge Head 100 and Liquid Feeding From the Liquid Discharge Head 100 to the Second Sub Tank 210

Ink is supplied to the first sub tank 220 using the first feeding pump 202 until the pressure sensor 233 detects a target pressure (for example, a positive pressure), and a liquid is supplied to the third sub tank 290 using the second feeding pump 203 until the pressure sensor 243 detects a target pressure (for example, a negative pressure), whereby a differential pressure is generated between the first sub tank 220 and the second sub tank 210.

In accordance with the differential pressure, circulation of the liquid is enabled from the first sub tank 220 to the second sub tank 210 via the liquid path 281, the filter 261, the degassing device 280, the first manifold 230, a plurality of supply paths 231, a plurality of first head tanks 300a, the plurality of liquid discharge heads 100, a plurality of discharge paths 241, a plurality of second head tanks 300b, the second manifold 240, and the liquid path 282. At this time, the solenoid valves 232 and 242 are open, and the solenoid valves 271 and 272 are closed.

That is, the first sub tank 220 is an example of a first tank that stores the liquid to be supplied to the liquid discharge head 100. Further, the second sub tank 210 is an example of a second tank that stores the liquid to be supplied to the first sub tank 220. Further, the second sub tank 210 is an example of a collection tank that stores the liquid collected from the liquid discharge head 100.

On the other hand, in a state in which the solenoid valves 232 and 242 are closed and the solenoid valves 271 and 272 are open, when the first feeding pump 202 and the second feeding pump 203 are driven to generate a differential pressure, circulation of the liquid is enabled, in accordance with the differential pressure, from the first sub tank 220 to the second sub tank 210 via the liquid path 281, the filter 261, the degassing device 280, the first manifold 230, the bypass path 270, the second manifold 240, and the liquid path 282.

That is, the liquid paths 281 to 284 are each an example of a liquid path through which the liquid flows from the second sub tank 210 to the liquid discharge head 100 via the first sub tank 220. Further, the liquid paths 281 to 284 are each an example of a liquid path through which the liquid flows from the first sub tank 220 to the second sub tank 210 via the liquid discharge head 100. In other words, the liquid paths 281 to 284 are each an example of a liquid path through which the liquid circulates via the liquid discharge head 100.

Further, the first feeding pump 202 and the second feeding pump 203 are each an example of a feeding pump that supplies the liquid from the second sub tank 210 to the liquid discharge head 100. Further, the first feeding pump 202 and the second feeding pump 203 are each an example of a feeding pump that feeds the liquid from the first sub tank 220 to the second sub tank 210 via the liquid discharge head 100. Further, the filter 261 is an example of a filter present on the liquid paths 281 to 284.

The liquid level detecting units 221, 211, and 291 provided in the respective sub tanks are not limited in particular, and, for example, a float-type method for detecting presence/absence of the liquid, a method for detecting presence/absence of the liquid in accordance with an output of a voltage detected using at least two electrode pins, a laser-based liquid level detecting method, or the like may be used.

Further, the solenoid valves 212, 222, and 292 as atmospheric opening mechanisms are provided in the respective sub tanks, and by controlling the solenoid valves 212, 222, and 292, the respective sub tanks are brought into communication with the atmosphere.

Next, roles of the gas chamber 220a of the first sub tank 220 and the gas chamber 210a of the second sub tank 210 will be described. In the gas chamber 220a and the gas chamber 210a, the liquid level of the liquid is, for example, in contact with air.

Here, when a pressurized state of air is generated in the first sub tank 220 and a depressurized state of air is generated in the second sub tank 210, since a gas has compressibility, the pressure can be stored. In this case, the air is regarded as corresponding to a capacitor component when expressed by an equivalent electrical circuit, and can also be referred to as compliance (an elastic component).

When the first feeding pump 202 and the second feeding pump 203, which communicate with the first sub tank 220 and the third sub tank 290 and with the second sub tank 210 and the third sub tank 290, are driven, a pressure fluctuation (pulsation) occurs. This pressure fluctuation is transmitted through the liquid paths, and when it is transmitted to a nozzle meniscus, it results in liquid overflow or entrainment of bubbles.

Accordingly, a compliance (an elastic component) may be provided to reduce the pressure fluctuation (pulsation). In general, air has compressibility and thus serves as a compliance component. By providing the gas chambers 220a and 210a, the pressure fluctuation (pulsation) can be reduced.

### Controller

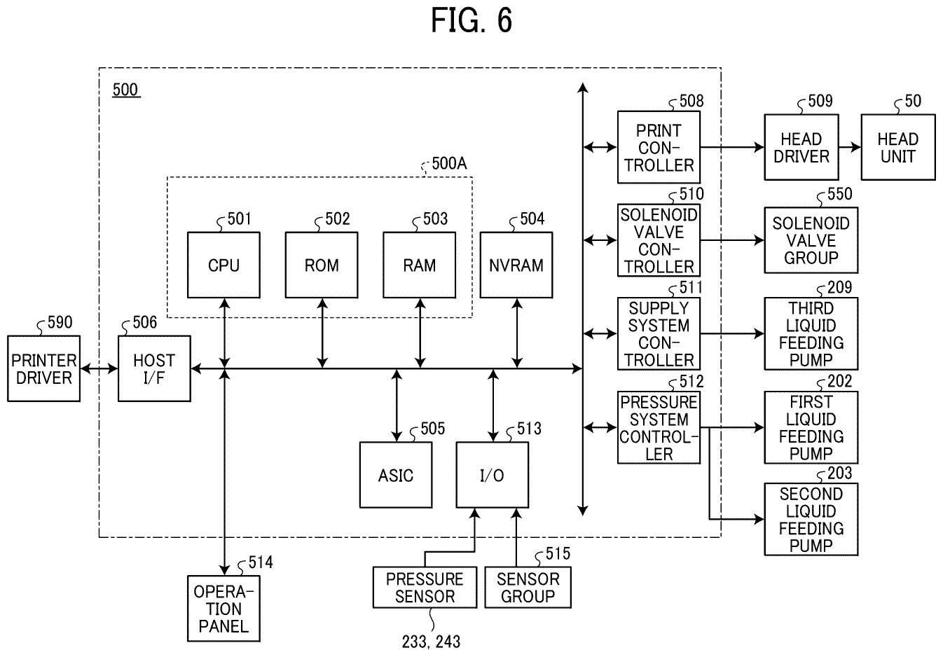

Next, an outline of the controller of the apparatus that discharges the liquid will be described with reference to FIG. 6. FIG. 6 is a functional block diagram of the controller.

The controller 500 includes a main controller 500A including a central processing unit (CPU) 501 that performs overall control of the apparatus, a read-only memory (ROM) 502 that stores fixed data such as various programs including a program to be executed by the CPU 501, and a random-access memory (RAM) 503 that temporarily stores image data and the like.

The controller 500 includes a rewritable non-volatile memory (NVRAM) 504 for retaining data even while the power of the apparatus is turned off. The controller 500 includes an application-specific integrated circuit (ASIC) 505 that performs image processing, such as various signal processing and sorting on image data, and processing of input and output signals for other controls. The controller 500 transmits and receives data to and from a printer driver 590 via a host interface (I/F) 506.

The controller 500 includes a print controller 508 including a data transfer unit, a drive signal generation unit, and a bias voltage output unit, which are used to control driving of each liquid discharge head 100 of the head unit 50, and a drive integrated circuit (IC) 509 that drives each liquid discharge head 100. The drive IC 509 is also referred to as “head driver”.

The controller 500 includes a solenoid valve controller 510 that controls driving of the solenoid valves 232, 242, 271, and 272 of a solenoid valve group 550, and the solenoid valves 212, 222, 292, 287, 288, and the like.

The controller 500 includes a supply system controller 511 that controls the third feeding pump 209.

The controller 500 includes a pressure system controller 512 that controls driving of the first feeding pump 202 and the second feeding pump 203.

The controller 500 includes an input/output (I/O) unit 513. The I/O unit 513 can process various sensor information, and obtains detection results of the pressure sensors 233 and 243 and information from various sensor groups 515. The controller 500 extracts information used for control of the apparatus, and uses the information for control by the print controller 508, the solenoid valve controller 510, the supply system controller 511, the pressure system controller 512, and the like.

An operation panel 514 for inputting and displaying information for the apparatus is coupled to the controller 500.

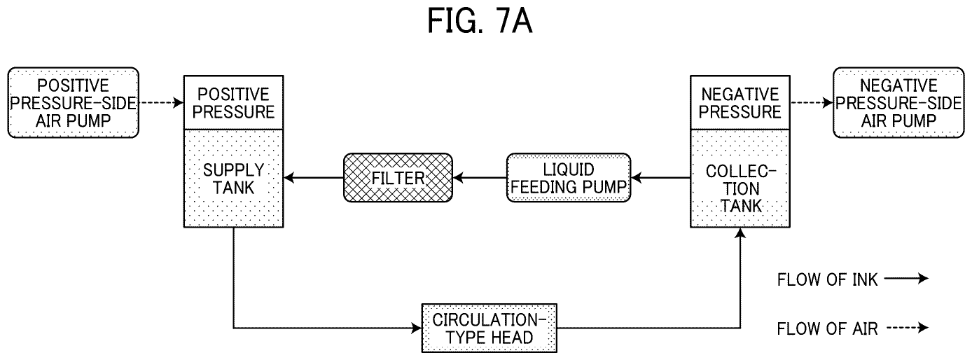

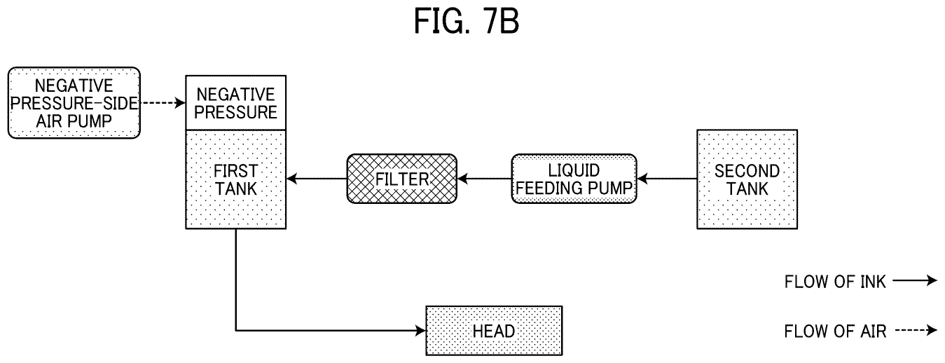

Next, an example of a configuration of a conventional liquid circulation system and a conventional liquid supply system will be described with reference to FIGS. 7A and 7B. FIGS. 7A and 7B are diagrams illustrating an example of a configuration of a conventional liquid circulation system and a conventional liquid supply system. In the conventional liquid circulation system, as illustrated in FIG. 7A, a positive pressure is applied to a supply tank, a negative pressure is applied to a collection tank, a circulation-type head is disposed between the supply tank and the collection tank, and ink is caused to flow through the circulation-type head in accordance with a differential pressure between the supply tank and the collection tank. A liquid such as ink that has flowed from the supply tank to the collection tank is returned from the collection tank to the supply tank through a filter by a feeding pump between the collection tank and the supply tank. In FIG. 7A, in a case where common liquid chamber circulation is employed, a negative pressure is applied to both the supply tank and the collection tank.

The liquid path coupling the supply tank and the circulation-type head is the first path. The liquid path coupling the collection tank and the circulation-type head is the second path. The liquid path coupling the supply tank and the collection tank is the second path. The feeding pump and the filter are disposed in the second path. The filter is disposed downstream of the feeding pump in a circulation direction of the liquid as indicated by arrow in FIG. 7A as a “flow of ink”.

In the liquid circulation system, when ink flows out from the supply tank, a volume of air in the supply tank increases and a pressure in the supply tank decreases. A decrease in the pressure in the supply tank is compensated by sending air with a positive pressure-side air pump coupled to the supply tank, thereby maintaining the pressure in the supply tank at a constant level.

Further, in the liquid circulation system, when ink flows into the collection tank, a volume of air in the collection tank decreases and a pressure in the collection tank increases (i.e., a negative pressure decreases). An increase in the pressure in the collection tank (i.e., a decrease in the negative pressure) is compensated by drawing out air with a negative pressure-side air pump coupled to the collection tank, thereby maintaining the pressure in the collection tank at a constant level.

When the ink in the supply tank decreases and the ink in the collection tank increases, it is desirable to return the ink from the collection tank to the supply tank by a feeding pump. When ink circulation is continued, the filter gradually becomes clogged, the filter reaches its lifetime, and, when ink feeding by the feeding pump does not keep up with a rate of ink decrease in the supply tank and a rate of ink increase in the collection tank, the supply tank becomes empty and ink overflows from the collection tank. However, as a criterion for determining the lifetime of the filter, the determination is made merely based on a period of use and an ink liquid passage amount through advance experiments, and thus it is desirable to make the determination with a sufficient margin.

In FIG. 7A, the liquid circulation system in which the liquid circulates from the supply tank to the collection tank via the circulation-type head has been described. And, as illustrated in FIG. 7B, a similar issue also arises in the liquid supply system in which the liquid flows to the head from a second tank to which the air pump is not coupled (i.e., pressure control is not performed), via a first tank to which the negative pressure-side air pump is coupled (i.e., pressure control is performed).

Accordingly, in the present embodiment, the controller 500 functions as an example of a controller that determines a lifetime of the filter 261 based on a value of the operating duty cycle of the first feeding pump 202 and the second feeding pump 203. Further, in the present embodiment, the controller 500 functions as an example of a controller that controls the feeding pumps based on the value of the operating duty cycle of the first feeding pump 202 and second feeding pump 203 obtained by the following equation (1). Accordingly, rather than uniformly determining the lifetime of the filter 261 based on a liquid passage amount, a liquid passage time, and the like, the lifetime of the filter 261 can be determined appropriately in consideration of an actual use condition. In the following description, the first feeding pump 202 and the second feeding pump 203 are collectively referred to as feeding pumps 202 and 203.

Operating duty cycle=operating time of the feeding pumps 202 and 203/(operating time of the feeding pumps 202 and 203+non-operating time of the feeding pumps 202 and 203) (1)

Here, the operating time of the feeding pumps 202 and 203 is a time period during which the feeding pumps 202 and 203 are turned on to feed the liquid, and the non-operating time of the feeding pumps 202 and 203 is a time period during which the feeding pumps 202 and 203 are turned off and do not feed the liquid.

For example, the controller 500 may determine that the filter 261 has reached its lifetime when the operating duty cycle becomes 100%. Accordingly, by determining the lifetime of the filter 261 at a timing at which the pump performance is utilized to the greatest extent, the lifetime of the filter 261 can be extended to the greatest extent.

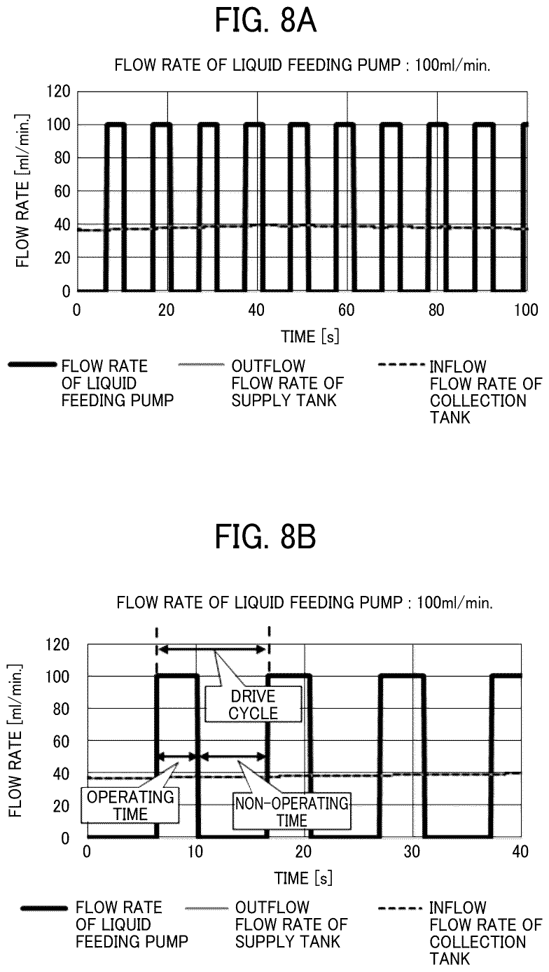

FIGS. 8A and 8B are graphs each illustrating an example of the liquid circulation apparatus according to the first embodiment. In FIGS. 8A and 8B, a vertical axis represents a flow rate of the liquid, and a horizontal axis represents time. FIG. 8B illustrates, when a circulation system during non-discharge from the liquid discharge head 100 is reproduced by simulation, a flow rate of the feeding pumps 202 and 203, an outflow flow rate of the liquid flowing out from the supply tank (the first sub tank 220), and an inflow flow rate of the liquid flowing into the collection tank (the second sub tank 210).

In this example, discharge of the liquid such as ink from the liquid discharge head 100 is not performed, and thus, the circulation amount of ink, the outflow flow rate of the supply tank, and the inflow flow rate into the collection tank are the same, and are about 38 mL/min. The filter 261 is new, and the feeding pumps 202 and 203 are assumed to exhibit performance of 100 mL/min. At this time, the feeding pumps 202 and 203 repeat an operating time of 3.8 seconds and a non-operating time of about 6.4 seconds, and the drive cycle is 10.2 seconds. Accordingly, the operating duty cycle is 37% (operating time÷drive cycle=3.8/10.2). Since this operating duty cycle can be obtained from the operating time and the non-operating time of the feeding pumps 202 and 203, it can be obtained by calculation using software counting.

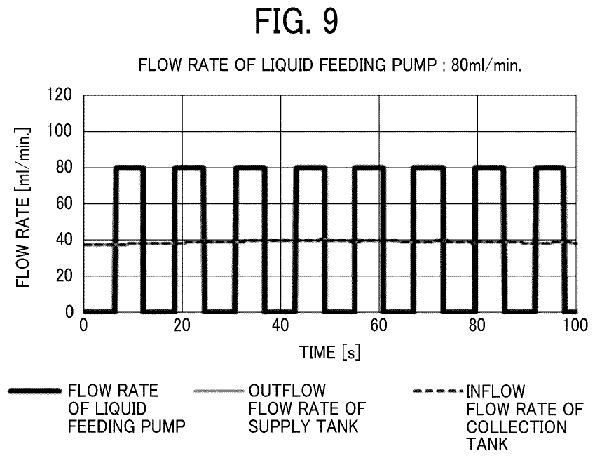

FIG. 9 is a graph illustrating an example of a simulation result assuming a case where, by passing the liquid through the filter, a fluid resistance value increases and the flow rate due to operation of the feeding pump decreases to 80 mL/min. In FIG. 9, a vertical axis represents a flow rate, and a horizontal axis represents time. In this case, an operating time of 5.6 seconds and a non-operating time of 6.4 seconds are repeated, and the operating duty cycle is 47%.

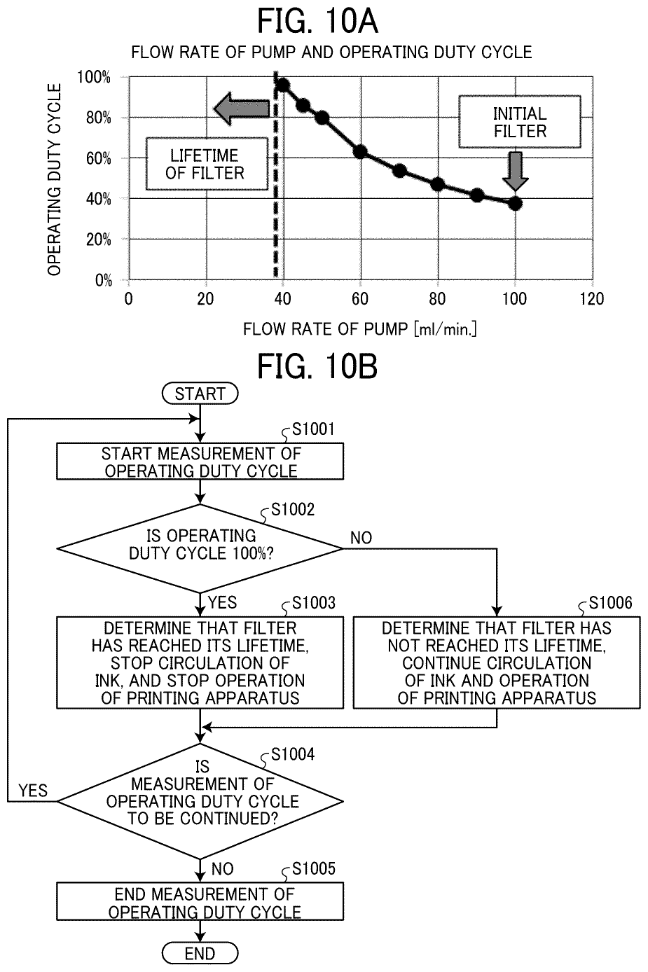

FIG. 10A is a graph illustrating an example of a result of calculating the operating duty cycle when the flow rate of the feeding pump is changed. When the flow rate (pump flow rate) of the feeding pumps 202 and 203 falls below an ink circulation amount of 38 mL/min, the pump flow rate is insufficient, and it means that, even when the feeding pumps 202 and 203 continue operating, ink feeding does not keep up. That is, when the filter 261 becomes clogged to the extent that an ink flow rate falls below 38 mL/min, the system cannot operate as intended, and the filter 261 can be determined to have reached its lifetime.

As described above, it is understood that when the fluid resistance value of the filter 261 increases due to liquid passage through the filter 261 and the flow rate of ink by the feeding pumps 202 and 203 decreases, the operating duty cycle of the feeding pumps 202 and 203 increases. Accordingly, when the operating duty cycle of the feeding pumps 202 and 203 reaches 100%, the filter 261 can be determined to have reached its lifetime.

FIG. 10B is a flowchart illustrating an example of a flow of a measurement process of the operating duty cycle in the liquid circulation apparatus according to the first embodiment. In the liquid circulation apparatus according to the present embodiment, when the controller 500 determines, based on measurement of the operating duty cycle, that the operating duty cycle is 100%, the controller 500 determines that the filter 261 has reached its lifetime, and stops circulation of ink and operation of the printing apparatus. Measurement of the operating duty cycle may be performed on an ongoing basis, or may be performed periodically.

Specifically, the controller 500 starts measurement of the operating duty cycle of the feeding pumps 202 and 203 (step S1001). Next, when the measured operating duty cycle is 100% (step S1002: Yes), the controller 500 determines that the filter 261 has reached its lifetime, stops circulation of the liquid such as ink, and stops operation of the image forming apparatus such as the printing apparatus (step S1003).

Thereafter, when measurement of the operating duty cycle is to be continued (step S1004: Yes), the process returns to step S1001. When measurement of the operating duty cycle is not to be continued (step S1004: No), measurement of the operating duty cycle ends (step S1005). On the other hand, when the measured operating duty cycle is not 100% (step S1002: No), the controller 500 determines that the filter 261 has not reached its lifetime, continues circulation of ink and operation of the printing apparatus (step S1006), and proceeds to step S1004.

As described above, according to the liquid circulation apparatus of the first embodiment, the lifetime of the filter 261 can be obtained from the operating duty cycle of the feeding pumps 202 and 203. Accordingly, an additional device such as a flow meter for measuring clogging of the filter 261 is not added, and the lifetime is not uniformly determined merely based on a liquid passage amount; therefore, the lifetime of the filter 261 can be obtained appropriately with a simple configuration.

### Second Embodiment

The present embodiment is an example in which when the operating duty cycle increases with supply of the liquid and exceeds a threshold that is less than 100%, the filter is determined to have reached its lifetime. In the following description, descriptions of configurations similar to those of the above-described embodiment are omitted.

In the present embodiment, the controller 500 determines that the filter 261 has reached its lifetime when the operating duty cycle increases with supply of the liquid and exceeds a threshold that is less than 100%. Accordingly, since the apparatus is stopped when the operating duty cycle reaches 100%, the lifetime of the filter 261 is determined in advance of the operating duty cycle reaching 100%, and, for example, replacement of the filter 261 can be performed at a timing when the apparatus is not in use.

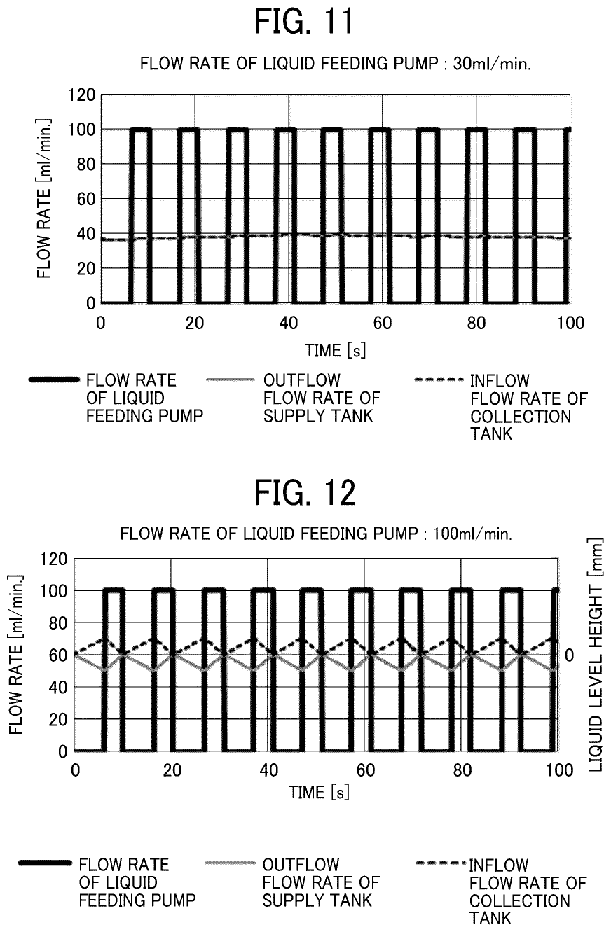

FIG. 11 is a graph illustrating an example of a simulation result when the flow rate of the feeding pump is 30 mL/min, which is below the ink circulation amount of 38 mL/min. In FIG. 11, a vertical axis represents a flow rate, and a horizontal axis represents time. In this case, the operating duty cycle of the feeding pumps 202 and 203 is 100% relative to the ink circulation amount (the outflow flow rate of the supply tank and the inflow flow rate of the collection tank), which means that the performance of the feeding pumps 202 and 203 is insufficient with respect to the ink circulation amount.

FIG. 12 is a graph illustrating transitions of liquid level heights of the supply tank and the collection tank when the flow rate of the feeding pump is 100 mL/min. In FIG. 12, a vertical axis represents a flow rate, and a horizontal axis represents time. The graph illustrates that the liquid level height is set such that an initial level is 0 mm, and that when the liquid level of the supply tank decreases to a certain level, the feeding pumps 202 and 203 operate, and, when the liquid level returns to the initial level, operation of the feeding pumps 202 and 203 stops.

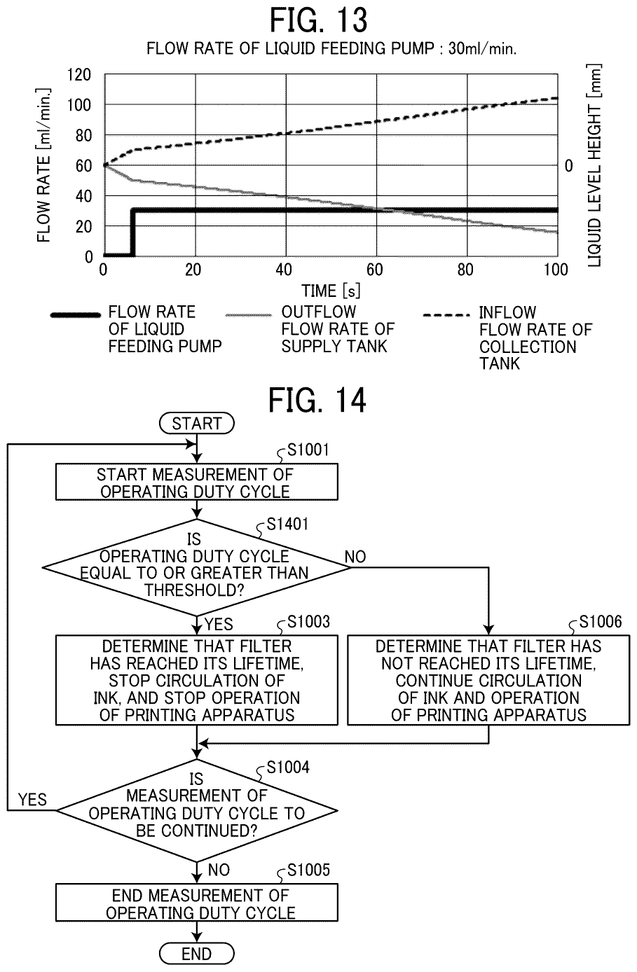

FIG. 13 is a graph illustrating transitions of liquid level heights of the supply tank and the collection tank when the flow rate of the feeding pump is 30 mL/min. In FIG. 13, a vertical axis represents a flow rate, and a horizontal axis represents time. In this case, the flow rate of the feeding pumps 202 and 203 is insufficient with respect to the ink circulation amount. Accordingly, ink in the supply tank continues to decrease, and, after the supply tank becomes empty, air is entrained into the liquid discharge head 100. Further, ink in the collection tank continues to increase, and ink overflows from the collection tank. Accordingly, it is preferable that operation of the circulation system be stopped promptly when the operating duty cycle becomes 100%; however, when the operating duty cycle becomes 100% during printing or the like, printing is stopped. Therefore, for example, the controller 500 may determine that the filter 261 has reached its lifetime when the operating duty cycle is 80% or 90%, or the like, with a sufficient margin.

FIG. 14 is a flowchart illustrating an example of a flow of a measurement process of the operating duty cycle in the liquid circulation apparatus according to the second embodiment. In the following description, description of processing similar to the processing illustrated in FIG. 10B is omitted. In the present embodiment, when the controller 500 determines that the measured operating duty cycle is equal to or greater than a threshold (step S1401: Yes), the process proceeds to step S1003, and when the controller 500 determines that the measured operating duty cycle is less than the threshold (step S1401: No), the process proceeds to step S1006.

As described above, according to the liquid circulation apparatus of the second embodiment, the apparatus is stopped when the operating duty cycle reaches 100%, and thus, the lifetime of the filter 261 is determined in advance of the operating duty cycle reaching 100%, and, for example, replacement of the filter 261 can be performed at a timing when the apparatus is not in use.

### Third Embodiment

The present embodiment is an example in which the filter is determined to have reached its lifetime when the feeding pump has continued operating for a predetermined period of time. In the following description, description of configurations similar to those of the above-described embodiments is omitted.

In the present embodiment, the controller 500 determines that the filter 261 has reached its lifetime when the feeding pumps 202 and 203 have continued operating for a predetermined period of time.

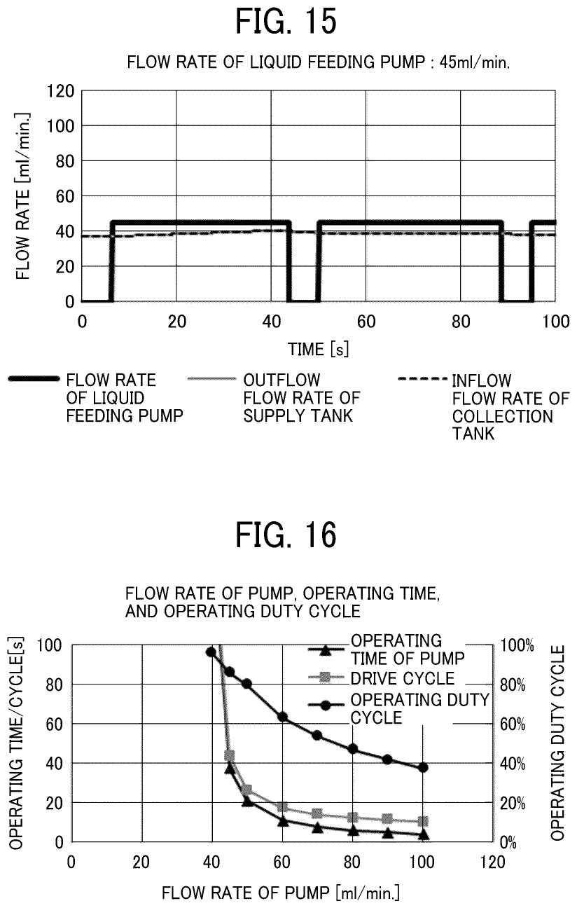

FIG. 15 is a graph illustrating an example of operation of the feeding pump when the flow rate of the feeding pump is 45 mL/min. In FIG. 15, a vertical axis represents a flow rate, and a horizontal axis represents time. It is understood that when the filter 261 becomes clogged and the ink flow rate decreases, the operating time of the feeding pumps 202 and 203 becomes longer.

FIG. 16 is a graph illustrating the operating time and a drive cycle of the feeding pump with respect to the operating duty cycle. In FIG. 16, a vertical axis represents an operating time (drive cycle), and a horizontal axis represents a flow rate of the feeding pumps 202 and 203. It is understood that, as the flow rate of the feeding pumps 202 and 203 decreases, the operating time per operation of the feeding pumps 202 and 203 increases. Accordingly, by determining the lifetime of the filter 261 based on the operating time of the feeding pumps 202 and 203 together with the operating duty cycle, accuracy of lifetime determination of the filter 261 can be improved.

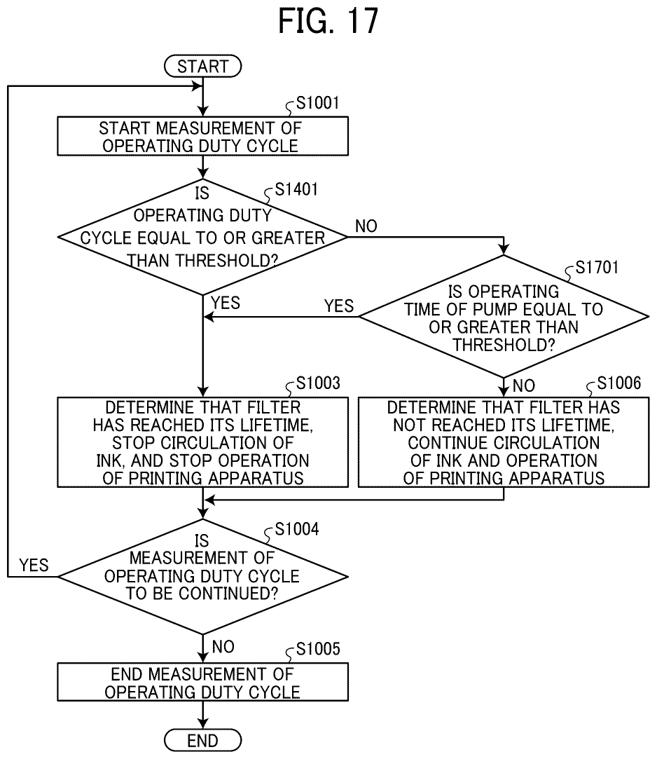

FIG. 17 is a flowchart illustrating an example of a flow of a measurement process of the operating duty cycle in the liquid circulation apparatus according to the third embodiment. In the following description, description of processing similar to the processing illustrated in FIG. 14 is omitted. In the present embodiment, when the operating duty cycle is less than the threshold (step S1401: No), the controller 500 determines whether the operating time of the feeding pumps 202 and 203 is equal to or greater than the threshold (step S1701). When the operating time of the feeding pumps 202 and 203 is equal to or greater than the threshold (step S1701: Yes), the controller 500 proceeds to step S1003. On the other hand, when the operating time of the feeding pumps 202 and 203 is less than the threshold (step S1701: No), the controller 500 proceeds to step S1006.

As described above, according to the liquid circulation apparatus of the third embodiment, accuracy of lifetime determination of the filter 261 can be improved.

### Fourth Embodiment

The present embodiment is an example in which the filter is determined to have reached its lifetime when the liquid has a maximum outflow from the head and the operating duty cycle of the feeding pump becomes 100%. In the following description, description of configurations similar to those of the above-described embodiments is omitted.

In the present embodiment, the controller 500 determines that the filter 261 has reached its lifetime when the liquid has the maximum outflow from the liquid discharge head 100 and the operating duty cycle of the feeding pumps 202 and 203 becomes 100%. Accordingly, by making the determination at a timing at which performance of the feeding pumps 202 and 203 is utilized to the greatest extent at a time of a maximum discharge flow rate from the circulation target medium (the liquid discharge head 100), the lifetime of the filter 261 can be extended to the greatest extent.

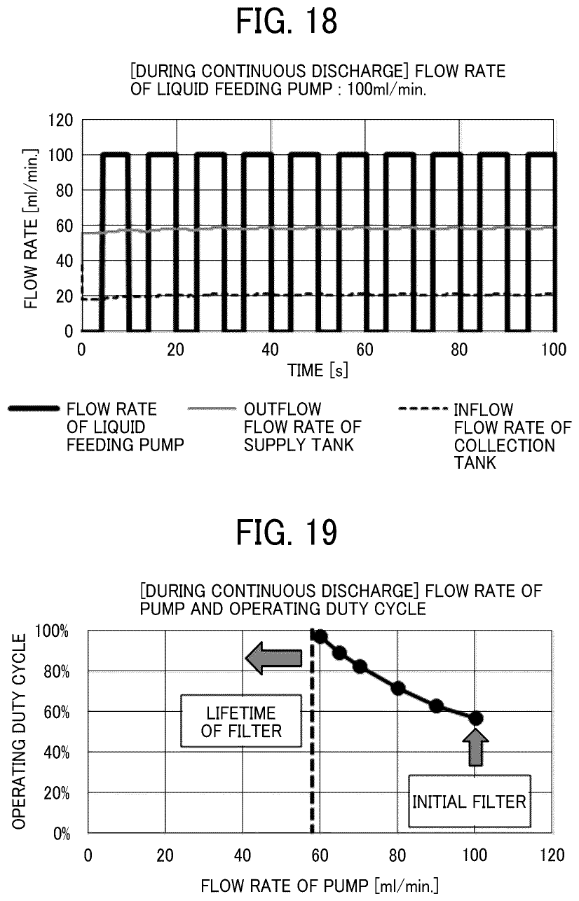

FIG. 18 is a graph illustrating the flow rate of the feeding pump, the outflow flow rate of the supply tank, and the inflow flow rate of the collection tank when the discharge flow from the head is continuously discharged with the ink circulation amount of 38 mL/min. In FIG. 18, a vertical axis represents a flow rate, and a horizontal axis represents time.

When the liquid such as ink is discharged from the liquid discharge head 100, the discharged ink is drawn and discharged from both a supply side and a collection side. A ratio of the discharge is determined based on a ratio between a fluid resistance value on the supply side as viewed from the nozzle 104 and a fluid resistance value on the collection side as viewed from the nozzle 104. In the present embodiment, calculation is performed for the liquid discharge head 100 in which the ratio is 1:1, and ink of 19 mL/min is drawn from the supply side and ink of 19 mL/min is also drawn from the collection side, and discharge corresponding to 38 mL/min is performed from the liquid discharge head 100. Accordingly, an outflow flow rate from the supply tank is 57 mL/min, and an inflow flow rate into the collection tank is 19 mL/min.

FIG. 19 is a graph illustrating an example of the operating duty cycle under the conditions illustrated in FIG. 18, assuming a case where the filter has been clogged and the flow rate of the feeding pump has decreased. In FIG. 19, a vertical axis represents an operating duty cycle, and a horizontal axis represents a flow rate of the feeding pumps 202 and 203. As illustrated in FIG. 19, when the flow rate of the feeding pumps 202 and 203 falls below 60 mL/min, the operating duty cycle becomes 100%, and the liquid feeding amount by the feeding pumps 202 and 203 becomes insufficient.

Specifically, when an outflow amount from the supply tank falls below 57 mL/min, even with the operating duty cycle being 100%, the liquid feeding amount by the feeding pumps 202 and 203 falls below the outflow amount from the supply tank, and an ink amount in the supply tank continues to decrease; therefore, the filter 261 is determined to have reached its lifetime. Accordingly, when the operating duty cycle of the feeding pumps 202 and 203 becomes 100% during ink discharge from the liquid discharge head 100, the filter 261 is determined to have reached its lifetime.

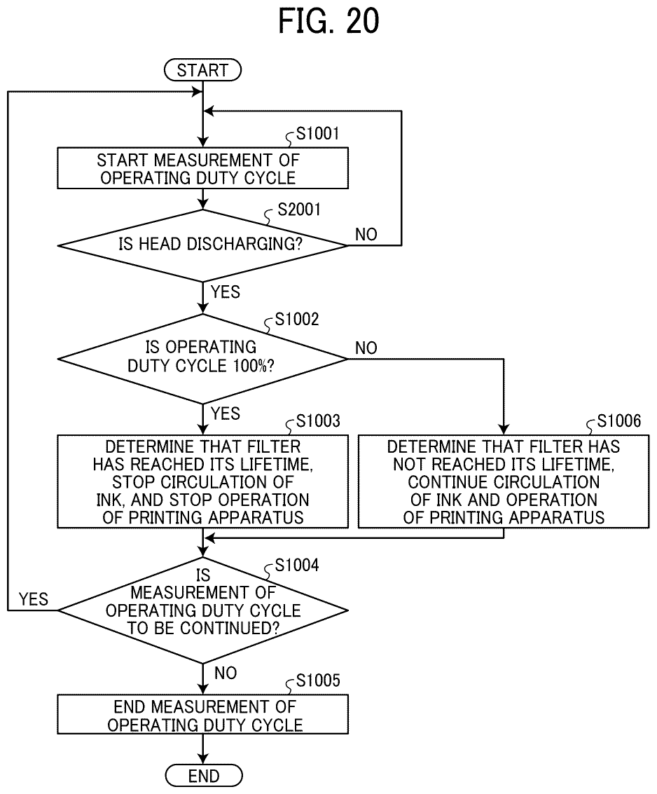

FIG. 20 is a flowchart illustrating an example of a flow of a measurement process of the operating duty cycle in the liquid circulation apparatus according to the fourth embodiment. In the following description, description of processing similar to the processing illustrated in FIG. 10B is omitted. In the present embodiment, when measurement of the operating duty cycle is started (step S1001), the controller 500 determines whether the liquid discharge head 100 is in a discharge state (step S2001). When the liquid discharge head 100 is discharging the liquid (step S2001: Yes), the controller 500 proceeds to step S1002. On the other hand, when the liquid discharge head 100 is not discharging the liquid (step S2001: No), the controller 500 returns to step S1001.

As described above, according to the liquid circulation apparatus of the fourth embodiment, by making the determination at a timing at which performance of the feeding pumps 202 and 203 is utilized to the greatest extent at a time of the maximum discharge flow rate from the circulation target medium (the liquid discharge head 100), the lifetime of the filter 261 can be extended to the greatest extent.

### Fifth Embodiment

The present embodiment is an example in which, when the outflow amount of the liquid from the head changes with time, the lifetime of the filter is determined in view of the operating duty cycle during non-outflow, based on the operating duty cycle during outflow of the liquid and the operating duty cycle during non-outflow of the liquid. In the following description, description of configurations similar to those of the above-described embodiments is omitted.

In the present embodiment, when the outflow amount of the liquid from the liquid discharge head 100 changes with time, the controller 500 determines the lifetime of the filter 261 in view of the operating duty cycle during non-outflow, based on the operating duty cycle during outflow of the liquid and the operating duty cycle during non-outflow of the liquid. Accordingly, the lifetime of the filter 261 can be determined during non-discharge, in which a stable operating duty cycle can be measured.

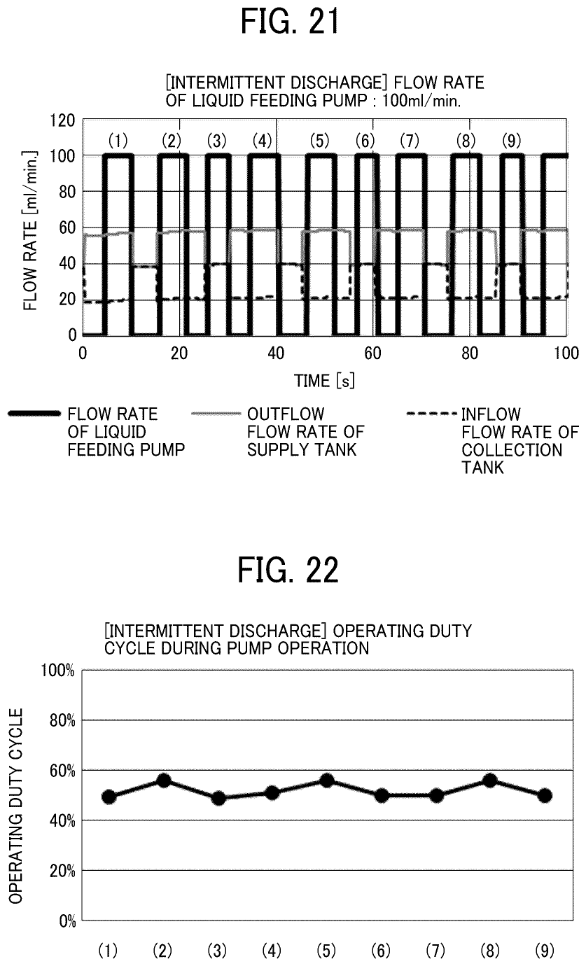

FIG. 21 is a graph illustrating an example of the flow rate of the feeding pump in an intermittent operation. In FIG. 21, a vertical axis represents a flow rate, and a horizontal axis represents time. Here, for ease of explanation, discharge for 10 seconds and non-discharge for 5 seconds are repeated; however, it is understood that the time of each of operating times (1) to (9) of the feeding pumps 202 and 203 is not constant.

FIG. 22 is a graph in which operations of the feeding pump at the operating times (1) to (9) illustrated in FIG. 21 are each indicated by an operating duty cycle. As illustrated in FIG. 22, the operating duty cycle varies between 49% and 56%. In the present embodiment, intermittent driving with a constant discharge flow rate is described; however, in actual printing, this means that the operating duty cycle varies between an operating duty cycle of 37% during non-discharge and an operating duty cycle of 57% during continuous discharge, depending on a print image, timing of a print job, and the like.

In such a case, it is difficult to obtain the lifetime of the filter 261 from the operating duty cycle, and thus, it is preferable to obtain the lifetime of the filter 261 using the operating duty cycle during non-discharge based on a relationship between the operating duty cycle during non-discharge when printing is not performed and a maximum operating duty cycle during printing.

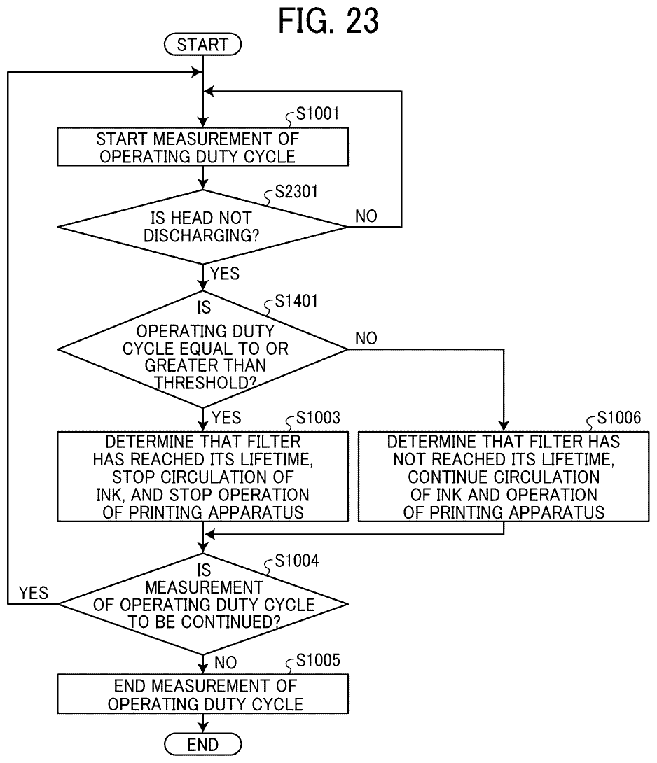

FIG. 23 is a flowchart illustrating an example of a flow of a measurement process of the operating duty cycle in the liquid circulation apparatus according to the fifth embodiment. In the following description, description of processing similar to the processing illustrated in FIG. 14 is omitted.

In the present embodiment, when measurement of the operating duty cycle is started (step S1001), the controller 500 determines whether the liquid discharge head 100 is in a non-discharge state (step S2301). When the liquid discharge head 100 is not discharging the liquid (step S2301: Yes), the controller 500 proceeds to step S1401. On the other hand, when the liquid discharge head 100 is discharging the liquid (step S2301: No), the controller 500 returns to step S1001.

As described above, according to the liquid circulation apparatus of the fifth embodiment, the lifetime of the filter 261 can be determined during non-discharge, in which a stable operating duty cycle can be measured.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

A liquid supply apparatus includes: a first tank to store a liquid to be supplied to a head, to discharge a liquid; a second tank to store the liquid to be supplied to the first tank; a liquid path including: a first path coupling the first tank and the head, to supply the liquid from the first tank to the head in a supply direction; a second path coupling the second tank and the first tank, to supply the liquid from the second tank to the first tank in the supply direction; a feeding pump in the second path and driven at an operating duty cycle, to feed the liquid from the second tank to the first tank; a filter disposed downstream from the feeding pump in the supply direction in the second path; and circuitry configured to: measure the operating duty cycle of the feeding pump; and determine a lifetime of the filter based on the operating duty cycle measured.

The liquid path further includes a third path coupling the head and the second tank, to collect the liquid from the head to the second tank in the supply direction, the second tank collects the liquid from the head and store the liquid to be supplied to the first tank, the feeding pump, in the second path, circulates the liquid from the first tank through the first path, the head, the third path, the second tank, and the second path back to the first tank, and the circuitry is further configured to control the feeding pump based on the operation duty cycle obtained by the following equation: the operation duty cycle=an operating time of the feeding pump/(an operating time of the feeding pump+a non-operating time of the feeding pump), wherein the operating time of the feeding pump is a time period during which the feeding pump is turned on to feed the liquid, and the non-operating time of the feeding pump is a time period during which the feeding pump is turned off and does not feed the liquid.

The circuitry is further configured to determine that the filter has reached the lifetime of the filter, when the operating duty cycle becomes 100%. The circuitry is further configured to determine that the filter has reached the lifetime of the filter, when the operating duty cycle: increases with supply of the liquid; and exceeds a threshold that is less than 100%. The circuitry is further configured to determine that the filter has reached the lifetime of the filter, when the operating duty cycle: increases with supply of the liquid; and becomes 90%.

The circuitry is further configured to determine that the filter has reached the lifetime of the filter, when the feeding pump has continued operating for a predetermined period of time.

The head has nozzles to discharge the liquid from the nozzles, and the circuitry is further configured to determine that the filter has reached a lifetime of the filter, when the head discharges the liquid from the nozzles at a maximum discharge flow rate; and the operating duty cycle of the feeding pump becomes 100%.

The head has nozzles to discharge the liquid from the nozzles, the circuitry is further configured to determine that the filter has reached the lifetime of the filter, when the operating duty cycle: increases with supply of the liquid; and exceeds a threshold that is less than 100%.

The circuitry is further configured to: control the head to discharge the liquid from the nozzles at a discharge flow rate changed with time, measure the operating duty cycle when the head discharges the liquid as a first duty cycle; and measure the operating duty cycle when the head does not discharge the liquid as a second duty cycle, determine that the filter has reached the lifetime of the filter when the head does not discharge the liquid, based on a relation between the first duty cycle to the second duty cycle.

The head has nozzles to discharge the liquid from the nozzles. The head further includes: a common liquid chamber communicating each of the nozzles to: supply the liquid to each of the nozzles; and collect the liquid not discharged from the nozzles.

The head has a liquid path in a vicinity of the nozzles to circulate the liquid through the head. An image forming apparatus includes: the liquid supply apparatus. A liquid discharge apparatus includes: the liquid supply apparatus.

According to the present embodiment, an effect is achieved in that the lifetime of the filter can be obtained appropriately with a simple configuration.

Note that, in the above-described embodiments, an example in which the image forming apparatus of the present embodiment is applied to a multifunction peripheral having at least two functions of a copy function, a printer function, a scanner function, and a facsimile function is described, but the embodiments can be applied to any image forming apparatus such as a copier, a printer, a scanner device, or a facsimile device.

Aspects of the present embodiment are, for example, as follows.

### First Aspect

According to a first aspect, a liquid supply apparatus includes:
a liquid supply target;
a first tank that stores a liquid to be supplied to the liquid supply target;
a second tank that stores the liquid to be supplied to the first tank;
a liquid path that the liquid flows through from the second tank to the liquid supply target via the first tank;
a feeding pump that supplies the liquid from the second tank to the liquid supply target;
a filter that is present on the liquid path; and
a controller that determines a lifetime of the filter based on a value of an operating duty cycle of the feeding pump.

### Second Aspect

According to a second aspect, a liquid supply apparatus includes:
a filter that is present on the liquid path; and
a controller that controls the feeding pump based on a value of an operating duty cycle of the feeding pump obtained by equation (1) below,
wherein the liquid supply target is a circulation target medium in which the liquid circulates,
the second tank stores the liquid collected from the circulation target medium,
the liquid path allows the liquid to flow through from the first tank to the second tank via the circulation target medium,
the feeding pump feeds the liquid from the first tank to the second tank via the circulation target medium, and
equation (1) is as follows:

the operating duty cycle=operating time of the feeding pump/(operating time of the feeding pump+non-operating time of the feeding pump) (1)
the operating time of the feeding pump being a time period during which the feeding pump is turned on to feed the liquid, and
the non-operating time of the feeding pump being a time period during which the feeding pump is turned off and does not feed the liquid.

### Third Aspect

According to a third aspect, in the liquid supply apparatus of the first aspect or the second aspect, the controller determines that the filter has reached a lifetime of the filter when the operating duty cycle becomes 100%.

### Fourth Aspect

According to a fourth aspect, in the liquid supply apparatus of the first aspect or the second aspect, when the operating duty cycle increases with supply of the liquid and exceeds a threshold that is less than 100%, the controller determines that the filter has reached a lifetime of the filter.

### Fifth Aspect

According to a fifth aspect, in the liquid supply apparatus of the fourth aspect, the controller determines that the filter has reached the lifetime of the filter when the feeding pump has continued operating for a predetermined period of time.

### Sixth Aspect

According to a sixth aspect, the liquid supply apparatus of the first aspect or the second aspect further includes:
an outflow unit that causes the liquid to flow out from the liquid supply target, wherein
the controller determines that the filter has reached a lifetime of the filter when the liquid has a maximum outflow from the liquid supply target and the operating duty cycle of the feeding pump becomes 100%.

### Seventh Aspect

According to a seventh aspect, the liquid supply apparatus of the fourth aspect further includes:
an outflow unit that causes the liquid to flow out from the liquid supply target,
wherein when the operating duty cycle increases with supply of the liquid and exceeds a threshold that is less than 100%, the controller determines that the filter has reached the lifetime of the filter.

### Eighth Aspect

According to an eighth aspect, in the liquid supply apparatus of the seventh aspect, when an outflow amount of the liquid from the liquid supply target changes with time, the controller determines the lifetime of the filter in view of the operating duty cycle during non-outflow, based on the operating duty cycle during outflow of the liquid and the operating duty cycle during non-outflow of the liquid.

### Ninth Aspect

According to a ninth aspect, in the liquid supply apparatus of any one of the sixth aspect to the eighth aspect, the liquid supply target is a head that discharges the liquid.

### Tenth Aspect

According to a tenth aspect, in the liquid supply apparatus of the ninth aspect, the head is a circulation-type liquid discharge head in which ink circulates in a common liquid chamber.

### Eleventh Aspect

According to an eleventh aspect, in the liquid supply apparatus of the ninth aspect, the head is a circulation-type liquid discharge head in which ink circulates in a vicinity of a nozzle.

### Twelfth Aspect

According to a twelfth aspect, an image forming apparatus is mounted with the liquid supply apparatus of any one of the first aspect to the eleventh aspect.

### Thirteenth Aspect

According to a thirteenth aspect, a liquid discharge apparatus is mounted with the liquid supply apparatus of any one of the first aspect to the eleventh aspect.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A liquid supply apparatus comprising:
a first tank to store a liquid to be supplied to a head, to discharge a liquid;
a second tank to store the liquid to be supplied to the first tank;
a liquid path including:
a first path coupling the first tank and the head, to supply the liquid from the first tank to the head in a supply direction;
a second path coupling the second tank and the first tank, to supply the liquid from the second tank to the first tank in the supply direction;
a feeding pump in the second path and driven at an operating duty cycle, to feed the liquid from the second tank to the first tank;
a filter disposed downstream from the feeding pump in the supply direction in the second path; and
circuitry configured to:
measure the operating duty cycle of the feeding pump; and
determine a lifetime of the filter based on the operating duty cycle measured.

2. The liquid supply apparatus according to claim 1,
wherein the liquid path further includes a third path coupling the head and the second tank, to collect the liquid from the head to the second tank in the supply direction,
the second tank collects the liquid from the head and store the liquid to be supplied to the first tank,
the feeding pump, in the second path, circulates the liquid from the first tank through the first path, the head, the third path, the second tank, and the second path back to the first tank, and
the circuitry is further configured to control the feeding pump based on the operation duty cycle obtained by a following equation:
the operation duty cycle=an operating time of the feeding pump/(an operating time of the feeding pump+a non-operating time of the feeding pump),
wherein the operating time of the feeding pump is a time period during which the feeding pump is turned on to feed the liquid, and
the non-operating time of the feeding pump is a time period during which the feeding pump is turned off and does not feed the liquid.

3. The liquid supply apparatus according to claim 1,
wherein the circuitry is further configured to determine that the filter has reached the lifetime of the filter,
when the operating duty cycle becomes 100%.

4. The liquid supply apparatus according to claim 1,
wherein the circuitry is further configured to determine that the filter has reached the lifetime of the filter,
when the operating duty cycle:
increases with supply of the liquid; and
exceeds a threshold that is less than 100%.

5. The liquid supply apparatus according to claim 4,
wherein the circuitry is further configured to determine that the filter has reached the lifetime of the filter,
when the operating duty cycle:
increases with supply of the liquid; and
becomes 90%.

6. The liquid supply apparatus according to claim 4,
wherein the circuitry is further configured to determine that the filter has reached the lifetime of the filter,
when the feeding pump has continued operating for a predetermined period of time.

7. The liquid supply apparatus according to claim 1,
wherein the head has nozzles to discharge the liquid from the nozzles, and
the circuitry is further configured to determine that the filter has reached a lifetime of the filter,
when the head discharges the liquid from the nozzles at a maximum discharge flow rate; and
the operating duty cycle of the feeding pump becomes 100%.

8. The liquid supply apparatus according to claim 1,
wherein the head has nozzles to discharge the liquid from the nozzles,
the circuitry is further configured to determine that the filter has reached the lifetime of the filter,
when the operating duty cycle:
increases with supply of the liquid; and
exceeds a threshold that is less than 100%.

9. The liquid supply apparatus according to claim 8,
wherein the circuitry is further configured to:
control the head to discharge the liquid from the nozzles at a discharge flow rate changed with time,
measure the operating duty cycle when the head discharges the liquid as a first duty cycle; and
measure the operating duty cycle when the head does not discharge the liquid as a second duty cycle,
determine that the filter has reached the lifetime of the filter when the head does not discharge the liquid,
based on a relation between the first duty cycle to the second duty cycle.

10. The liquid supply apparatus according to claim 1,
wherein the head has nozzles to discharge the liquid from the nozzles.

11. The liquid supply apparatus according to claim 10,
wherein the head further includes:
a common liquid chamber communicating each of the nozzles to:
supply the liquid to each of the nozzles; and
collect the liquid not discharged from the nozzles.

12. The liquid supply apparatus according to claim 10,
wherein the head has a liquid path in a vicinity of the nozzles to circulate the liquid through the head.

13. An image forming apparatus comprising:
the liquid supply apparatus according to claim 1.

14. A liquid discharge apparatus comprising:
the liquid supply apparatus according to claim 1.
